(19) United States
(12) Patent Application Publication
(10) Pub. No.: US 2025/0101242 A1
(43) Pub. Date: Mar. 27, 2025

(54) WHITE INKJET INKS

(71) Applicant: MEMJET TECHNOLOGY LIMITED, Leopardstown (IE)

(72) Inventors: Simon Fielder, North Ryde (AU); Ivan Johan, North Ryde (AU)

(21) Appl. No.: 18/814,824

(22) Filed: Aug. 26, 2024

Related U.S. Application Data
(60) Provisional application No. 63/539,649, filed on Sep. 21, 2023.

(51) Int. Cl. C09D 11/322; C09D 11/033; C09D 11/037; C09D 11/38

(52) U.S. Cl. CPC C09D 11/322; C09D 11/033; C09D 11/037; C09D 11/38

(57) ABSTRACT

A white inkjet ink includes: an aqueous-based ink vehicle and white pigment particles dispersed in the ink vehicle. The pigment particles are core-shell particles having a core comprised of polystyrene and a shell comprised of titania. Stable formulations producing good image quality include a first nonionic acetylenic surfactant having an HLB value in the range of 7 to 9 and a second nonionic acetylenic surfactant having an HLB value in the range of 12 to 14.

### CROSS-REFERENCE TO RELATED APPLICATIONS

This application claims the benefit of priority to U.S. Provisional Patent App. Ser. No. 63/539,649 filed Sep. 21, 2023, of the same title, the contents of which being incorporated herein by reference in its entirety.

### FIELD

This disclosure relates to an aqueous-based inkjet ink comprising a white pigment. It has been developed primarily for printing onto non-white media using conventional thermal inkjet printing technology.

### BACKGROUND

The present Applicant has developed a plethora of high-speed inkjet printers employing stationary Memjet® printheads which extend across a media width. By contrast, most other types of inkjet printer utilize a scanning printhead which traverses across the media width.

High-speed pagewide printing necessarily places additional demands on the design of the printhead compared to traditional types of inkjet printhead. The nozzle devices must have a self-cooling design, high ink refill rates and high thermal efficiency. To this end, the Applicant has developed a range of thermal bubble-forming printheads, including those with suspended resistive heater elements (as described in, for example, U.S. Pat. Nos. 6,755,509; 7,246,886; 7,401,910; and 7,658,977, the contents of which are incorporated herein by reference in their entireties) and those with embedded (“bonded”) resistive heater elements (as described in, for example, U.S. Pat. Nos. 7,377,623; 7,431,431; 9,950,527; 9,283,756 and 9,994,017, the contents of which are incorporated herein by reference in their entireties).

Typical inkjet inks for printing onto white media (e.g. white paper) are aqueous cyan, magenta, yellow and black inks. Expansion of inkjet technology into fields other than traditional paper-based printing requires different inks. Printing onto non-white media, such as corrugated packaging, transparent films, metals and the like necessitates white inks, in addition to conventional CMYK inks.

White inks present a unique challenge for inkjet printing, because white pigment particles such as TiO₂ and SiO₂ have a relatively high density and are difficult to disperse in aqueous ink vehicles. White pigment dispersions are prone to settling and therefore require sophisticated ink delivery systems, which can agitate the ink to minimize pigment settling and/or recirculate the ink through the printhead to minimize clogging of nozzles. Therefore, inkjet printing using white inks presents significant hardware design challenges.

A more attractive approach for inkjet printing using white inks is to use more stable white pigment dispersions, which are less prone to settling. The use of low-density hollow microspheres instead of conventional solid pigment particles has been proposed as a means for addressing the problem of white pigment dispersibility. U.S. Pat. No. 9,878,920 (assigned to Hewlett-Packard Development Company, L.P.) describes a white pigment dispersion comprising hollow microspheres of titania having a particle size of 100 to 300 nm. The low-density titania particles may be dispersed more readily than conventional solid titania pigments.

As described in U.S. Pat. No. 9,080,072 (assigned to Hewlett-Packard Development Company, L.P.), the opacity of titania dispersions is understood to be optimized with particle sizes in the range of 200 to 250 nm. U.S. Pat. No. 9,080,072 suggests that the opacity of smaller, more dispersible titania particles, having a particle size of less than 50 nm, may be increased via formulation with a latex emulsion comprising polymer particles (e.g., perfluorohexane) having a particle size of 100 to 1000 nm. The relatively larger polymer particles serve as optical spacers, which assist in scattering reflected light backwards towards the light source, thereby increasing opacity.

It would be desirable to provide alternative aqueous-based white inkjet inks compatible with thermal inkjet printing technology.

### SUMMARY

In a first aspect, there is provided a white inkjet ink. In one embodiment, the white inkjet ink includes:
an aqueous-based ink vehicle; and
pigment particles dispersed in the ink vehicle,
wherein the pigment particles are core-shell particles having a core comprised of polystyrene and a shell comprised of titania.

The inkjet inks according to the first aspect have excellent opacity compared to other white inks known in the art and form relatively stable dispersions due to the intrinsic buoyancy of the low-density core-shell particles. Furthermore, in contrast with hollow microspheres described in the prior art, the core-shell particles used in the above-described white ink may be produced at a relatively lower cost since they do not require high-temperature sintering, which is a necessary step in the production of hollow microspheres.

Preferably, the pigment particles have an average particle size in the range of 500 to 900 nm, or preferably 600 to 800 nm. Surprisingly, particle sizes of 500 to 800 nm produce inks having maximum opacity compared to smaller particle sizes of 200 to 300 nm. Theoretical calculations as well as literature precedent (see, for example, U.S. Pat. No. 9,080,072) predict that relatively smaller particles are optimal for maximizing opacity. Therefore, the core-shell particles described herein serendipitously exhibit unique behavior in inkjet inks compared to known white pigment particles, such as the hollow microspheres described in U.S. Pat. No. 9,878,920.

Preferably, the pigment particles have a shell thickness in the range of 10 to 60 nm.

Preferably, the titania shell is coated to the polystyrene core via a layer of polyvinylpyrrolidone (PVP). The PVP layer promotes adsorption of titania to the polystyrene surface, thereby optimizing stability and yields.

Preferably, the ink vehicle comprises one or more nonionic acetylenic surfactants.

Preferably, the nonionic acetylenic surfactants each have an HLB value in the range of 7 to 14.

Preferably, the ink vehicle comprises a first nonionic acetylenic surfactant having an HLB value in the range of 7 to 9, and a second nonionic acetylenic surfactant having an HLB value in the range of 12 to 14. This surfactant combination mediates interaction between the pigment surface and the aqueous ink vehicle resulting in improved image quality and a more uniform pigment coating in drawdown tests.

Preferably, the ink vehicle further comprises a nonionic siloxane-based surfactant. The combination of siloxane-based surfactants with certain acetylenic surfactants provides improved image quality in drawdown tests compared to surfactant packages lacking the siloxane-based surfactant.

Preferably, the ink vehicle comprises water and one or more co-solvents.

Preferably, the ink vehicle comprises one or more co-solvents selected from the group consisting of: glycol ethers, 1,2-alkyldiols, ethylene glycol, diethylene glycol, triethylene glycol and glycerol.

The ink vehicle may comprises other additives, which will be well known to the person skilled in the art. For example, the ink vehicle may comprise one or more additives selected from the group consisting of: pigment dispersants, biocides, pH adjusters, anti-kogation additives and anti-corrosion additives.

In a second aspect, there is provided a white pigment dispersion suitable for formulating an inkjet ink. In one embodiment, the white pigment dispersion comprising core-shell particles having a core comprised of polystyrene and a shell comprised of titania, wherein the core-shell particles have an average particle size in the range of 500 to 900 nm.

In a third aspect, there is provided a white inkjet ink comprising:
an aqueous-based ink vehicle; and
pigment particles having a titania outer surface dispersed in the ink vehicle,
wherein the ink vehicle comprises a first nonionic acetylenic surfactant having an HLB value in the range of 7 to 9; and a second nonionic acetylenic surfactant having an HLB value in the range of 12 to 14.

Preferably, the ink further comprises a nonionic siloxane-based surfactant, such as a polyether-modified siloxane.

### DETAILED DESCRIPTION

The present inventors sought a solution to the problem of providing a commercially-viable white inkjet ink, which is suitable for use in thermal inkjet printheads. In particular, the white ink should preferably have high opacity, as well as good dispersibility, stability and image quality when printed on media.

Polystyrene-titania core-shell particles are known in the literature primarily as precursors in the synthesis of hollow titania microspheres (see, for example, Wang et al, Ceramics International, 44 (2018), 4981-4989). Once titania is coated onto a polystyrene scaffold, the polystyrene may be removed by sintering at high temperature to yield hollow titania particles.

The present inventors hypothesized that titania-coated polystyrene particles (“PS@TiO₂”), an intermediate in the synthesis of hollow titania microspheres, would have sufficient buoyancy to be formulated in inkjet inks and have interesting optical properties that had hitherto not been investigated for use in white inks.

Surprisingly, it was found that the PS@TiO₂ particles had optical properties that confounded theoretical predictions of optimum particle sizes for producing maximum opacity when printed on media. Without wishing to be bound by theory, the present inventors believe that light traversing the core-shell interface may be responsible for this unique behavior in the present disclosure. Such unique behavior has not been investigated in the production of aqueous-based white inkjet inks and provides a promising alternative to white inks that make use of, for example, hollow titania microspheres.

In addition to the unique optical properties of PS@TiO₂ particles in white ink formulations, it was found that image quality using white ink formulations could be optimized with a combination of nonionic acetylenic surfactants, typically a first nonionic acetylenic surfactant having an HLB value in the range of 7 to 9 and a second nonionic acetylenic surfactant having an HLB value in the range of 12 to 14. Without wishing to be bound by theory, it is understood by the present inventors that the improved image quality may result from optimal interaction with the titania surface—the relatively higher HLB surfactant provides good solubility in the aqueous medium, while the relatively lower HLB surfactant interacts to a greater extent with the titania surface. Further improvements in image quality were observed with the addition of a nonionic siloxane-based surfactant, such as a polyether-modified siloxane (e.g., BYK349 sold by BYK Japan K.K.).

### Ink Vehicle—

The ink vehicles used in the present disclosure are typically conventional aqueous ink vehicles comprising at least 40 wt % water, at least 50 wt % water or at least 60 wt % water. Usually, the amount of water present in the inkjet ink is in the range of 40 wt % to 90 wt %, or optionally in the range of 50 wt % to 70 wt %.

Inks according to the present disclosure may further comprise co-solvents (including humectants, penetrants, wetting agents etc.), pigment dispersants, surfactants, biocides, anti-kogation additives, anti-corrosion additives, sequestering agents, pH adjusters, viscosity modifiers, etc.

Co-solvents are typically water-soluble organic solvents. Suitable water-soluble organic solvents include C₁₋₄ alkyl alcohols, such as ethanol, methanol, butanol, propanol, and 2-propanol; alkylene glycols, such as ethylene glycol, diethylene glycol, triethylene glycol and tetraethylene glycol; glycol ethers, such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-isopropyl ether, diethylene glycol mono-isopropyl ether, ethylene glycol mono-n-butyl ether, diethylene glycol mono-n-butyl ether, triethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-isopropyl ether, dipropylene glycol monomethyl ether, dipropylene glycol monoethyl ether, dipropylene glycol mono-n-propyl ether, dipropylene glycol mono-isopropyl ether, propylene glycol mono-n-butyl ether, and dipropylene glycol mono-n-butyl ether; formamide, acetamide, dimethyl sulfoxide, sorbitol, sorbitan, glycerol monoacetate, glycerol diacetate, glycerol triacetate, and sulfolane; or combinations thereof.

Other useful water-soluble organic solvents, which may be used as co-solvents, include polar solvents, such as 2-pyrrolidone, N-methylpyrrolidone, [symbol] -caprolactam, dimethyl sulfoxide, morpholine, N-ethylmorpholine, 1,3-dimethyl-2-imidazolidinone and combinations thereof.

The inkjet ink may contain another high-boiling water-soluble organic solvent as a co-solvent, which can serve as a wetting agent or humectant for imparting water retentivity and wetting properties to the ink composition. Examples of high-boiling water-soluble organic solvents are 2-butene-1,4-diol, 2-ethyl-1,3-hexanediol, 2-methyl-2,4-pentanediol, tripropylene glycol monomethyl ether, dipropylene glycol monoethyl glycol, dipropylene glycol monoethyl ether, dipropylene glycol monomethyl ether, dipropylene glycol, triethylene glycol monomethyl ether, diethylene glycol monobutyl ether, diethylene glycol monoethyl ether, diethylene glycol monomethyl ether, tripropylene glycol, polyethylene glycols having molecular weights of 2000 or lower, 1,3-propylene glycol, isopropylene glycol, isobutylene glycol, 1,4-butanediol, 1,3-butanediol, 1,5-pentanediol, 1,6-hexanediol, glycerol, trimethylolpropane, erythritol, pentaerythritol and combinations thereof.

Other suitable wetting agents or humectants include saccharides (including monosaccharides, oligosaccharides and polysaccharides) and derivatives thereof (e.g. maltitol, sorbitol, xylitol, hyaluronic salts, aldonic acids, uronic acids etc.)

The inkjet ink may also contain a penetrant, as one of the co-solvents, for accelerating penetration of the aqueous ink into the recording medium. Suitable penetrants include polyhydric alcohol alkyl ethers (glycol ethers) and/or 1,2-alkyldiols. Examples of suitable polyhydric alcohol alkyl ethers are ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, ethylene glycol mono-n-propyl ether, ethylene glycol mono-isopropyl ether, diethylene glycol mono-isopropyl ether, ethylene glycol mono-n-butyl ether, diethylene glycol mono-n-butyl ether, triethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-isopropyl ether, dipropylene glycol monomethyl ether, dipropylene glycol monoethyl ether, dipropylene glycol mono-n-propyl ether, dipropylene glycol mono-isopropyl ether, propylene glycol mono-n-butyl ether, and dipropylene glycol mono-n-butyl ether. Examples of suitable 1,2-alkyldiols are 1,2-pentanediol and 1,2-hexanediol. The penetrant may also be selected from straight-chain hydrocarbon diols, such as 1,3-propanediol, 1,4-butanediol, 1,5-pentanediol, 1,6-hexanediol, 1,7-heptanediol, and 1,8-octanediol. Glycerol may also be used as a penetrant.

Typically, the total amount of co-solvent present in the ink is in the range of about 5 wt % to 60 wt %, or optionally 10 wt % to 50 wt %.

### Surfactant—

Inks according to the present disclosure typically comprise one or more surfactants. For example, anionic surfactants, zwitterionic surfactants and nonionic surfactants may be included in the ink vehicle to assist in tuning ink properties.

Useful anionic surfactants include sulfonic acid types, such as alkanesulfonic acid salts, [symbol] -olefinsulfonic acid salts, alkylbenzenesulfonic acid salts, alkylnaphthalenesulfonic acids, acylmethyltaurines, and dialkylsulfosuccinic acids; alkylsulfuric ester salts, sulfated oils, sulfated olefins, polyoxyethylene alkyl ether sulfuric ester salts; carboxylic acid types, e.g., fatty acid salts and alkylsarcosine salts; and phosphoric acid ester types, such as alkylphosphoric ester salts, polyoxyethylene alkyl ether phosphoric ester salts, and glycerophosphoric ester salts. Specific examples of the anionic surfactants are di (C6-30 alkyl) sulfosuccinate sodium salt, sodium dodecylbenzenesulfonate, sodium laurate, and a polyoxyethylene alkyl ether sulfate ammonium salt.

Examples of zwitterionic surfactants include N,N-dimethyl-N-octyl amine oxide, N,N-dimethyl-N-dodecyl amine oxide, N,N-dimethyl-N-tetradecyl amine oxide, N,N-dimethyl-N-hexadecyl amine oxide, N,N-dimethyl-N-octadecyl amine oxide and N,N-dimethyl-N—(Z-9-octadecenyl)-N-amine oxide.

Examples of nonionic surfactants include ethylene oxide adduct types, such as polyoxyethylene alkyl ethers, polyoxyethylene alkylphenyl ethers, polyoxyethylene alkyl esters, and polyoxyethylene alkylamides; polyol ester types, such as glycerol alkyl esters, sorbitan alkyl esters, and sugar alkyl esters; polyether types, such as polyhydric alcohol alkyl ethers; and alkanolamide types, such as alkanolamine fatty acid amides. Specific examples of nonionic surface active agents are ethers such as polyoxyethylene nonylphenyl ether, polyoxyethylene octylphenyl ether, polyoxyethylene dodecylphenyl ether, polyoxyethylene alkylallyl ether, polyoxyethylene oleyl ether, polyoxyethylene lauryl ether, and polyoxyalkylene alkyl ethers (e.g. polyoxyethylene alkyl ethers); and esters, such as polyoxyethylene oleate, polyoxyethylene oleate ester, polyoxyethylene distearate, sorbitan laurate, sorbitan monostearate, sorbitan mono-oleate, sorbitan sesquioleate, polyoxyethylene mono-oleate, and polyoxyethylene stearate.

As described above, in one preferred embodiment, the ink vehicle comprises ethoxylated acetylenic diol-based surfactants, such as Surfynols® (commercially available from Air Products and Chemicals, Inc). For example, the ink vehicle may comprise a first nonionic acetylenic surfactant having an HLB value in the range of 7 to 9 (e.g. Surfynol® 2502) and a second nonionic acetylenic surfactant having an HLB value in the range of 12 to 14 (e.g. Surfynol 465).

As described above, the ink vehicle may also comprise a nonionic polyether-modified siloxane surfactant, such BYK-345, BYK-346 or BYK-349 (commercially available from BYK Japan K.K.), as well as SilfaceTM SAG-002, SAG-005, SAG-008, SAG-KB and SAG-503A (commercially available from Nissin Chemical Industry Co. Ltd.).

The total amount of surfactant(s) present in the ink is typically in an amount ranging from 0.05 wt. % to 3 wt % or 0.1 to 2.5 wt. %. Typically, the surfactant(s) are added in sufficient quantities to adjust the surface tension of the ink within the range of 27 to 31 mN/m, or preferably 28 to 30 mN/m, suitable for thermal inkjet printing.

### Other Additives—

The ink may also comprise a pigment dispersant, such as polyvinylpyrrolidone. Other examples of pigment dispersants will be well known to the person skilled in the art. Typical examples include polyvinyl alcohols, polyacrylic acid, polyacrylic acid-styrene copolymers, polyesters, polyurethanes, polyvinyl chloride, polyvinyl chloride-vinyl acetate copolymers, vinyl chloride-modified polyacrylic acid, polyoxyalkylene-added polyalkyleneamine and polyvinyl butyral. The pigment dispersant may be present in an amount ranging from 0.1 to 5 wt. %.

The ink may also include a pH adjuster or buffer, such as sodium hydroxide, potassium hydroxide, lithium hydroxide, sodium carbonate, sodium hydrogencarbonate, potassium carbonate, potassium hydrogencarbonate, lithium carbonate, sodium phosphate, potassium phosphate, lithium phosphate, potassium dihydrogenphosphate, dipotassium hydrogenphosphate, sodium oxalate, potassium oxalate, lithium oxalate, sodium borate, sodium tetraborate, potassium hydrogenphthalate, and potassium hydrogentartrate; ammonia; and amines, such as methylamine, ethylamine, diethylamine, trimethylamine, triethylamine, tris (hydroxymethyl) aminomethane hydrochloride, triethanolamine, diethanolamine, diethylethanolamine, triisopropanolamine, butyldiethanolamine, morpholine, propanolamine, 4-morpholineethanesulfonic acid and 4-morpholinepropanesulfonic acid (“MOPS”). The amount of pH adjuster, when present, is typically in the range of from 0.01 to 2 wt. % or 0.05 to 1 wt. %.

The ink may also include a biocide, such as benzoic acid, dichlorophene, hexachlorophene, sorbic acid, hydroxybenzoic esters, sodium dehydroacetate, 1,2-benthiazolin-3-one (“Proxel® GXL”, available from Arch Chemicals, Inc.), 3,4-isothiazolin-3-one or 4,4-dimethyloxazolidine. The amount of biocide, when present, is typically in the range of from 0.01 to 2 wt. % or 0.05 to 1 wt. %.

The ink may also contain a sequestering agent, such as ethylenediaminetetraacetic acid (EDTA).

The ink may contain certain metals salts, particularly trivalent metal salts, such as an aluminium salt and/or gallium salt for the purpose of minimizing dissolution of silica in nozzle chambers over the lifetime of the printhead. Suitable trivalent metals salts are described in, for example, WO2012/151630, the contents of which is incorporated herein by reference.

The ink may additionally contain small quantities (e.g. 2 to 90 ppm) of ammonium salts (e.g. ammonium nitrate, ammonium formate, etc.) for the purpose of minimizing heater delamination and extending the lifetime of the printhead. Ink formulations containing such ammonium salts are described in WO2020/038725, the contents of which are incorporated herein by reference in its entirety.

### Inkjet Printheads—

The inks according to the present disclosure are primarily for use in connection with thermal inkjet printheads, although they may of course be used in other types of printhead. An exemplary type of inkjet printhead is described in, for example, U.S. Pat. Nos. 9,950,527, 9,283,756 and 9,994,017, the contents of each of which are incorporated herein by reference in their entireties.

### Experimental Section—

### Preparation of Polystyrene Particles via Dispersion Polymerization—

PVP (3.0 g) was dissolved in ethanol (10 mL) using ultrasonication to prepare an ethanolic dispersion of PVP. Into a 250 ml three-necked round bottom flask (equipped with a reflux condenser and a gas inlet), de-inhibited styrene (3 mL), ethanol (46 mL), ultrapure water (10 mL), azobisisobutyronitrile (AIBN) (0.3 g), and ethanolic PVP solution, were added. To remove dissolved oxygen in the reagent, the reaction mixture was sparged with N2 gas for 30 minutes under stirring before it was heated at 70° C. in a silicone oil bath to initiate polymerization. The reaction was left for 90 minutes before a pre-mixed mixture containing de-inhibited styrene (3 mL), ethanol (56 mL), [(2-methacryloyloxy) ethyl] trimethyl ammonium chloride (MTC) (109 μL) was fed into the reaction mixture by dropwise addition within 2 hours. The reaction was left for 24 hours before the polymerization was stopped by exposing the polymer dispersion to ambient air. The monomer conversion was determined gravimetrically by measuring the weight of the latex after drying it in a vacuum oven for 24 hours. The observed weight was then divided by the total amount of the monomer fed into the reactor to obtain the particle conversion.

### Preparation of Polystyrene Particles via Soap-free Emulsion Polymerization—

Ultrapure water (204.5 mL) and de-inhibited styrene (12.5 mL) were added into a 500 ml three-necked round bottom flask equipped with reflux condenser and gas inlet, to make a dispersion mixture with a total volume of 217 mL. The mixture was then degassed by sparging with N2 gas for 30 minutes under stirring before it was heated to 70° C. to achieve temperature equilibrium. Then, a pre-mixed mixture containing 2,2′-azobis (2-methylpropionamidine) dihydrochloride (V-50) (0.18 g) and ultrapure water (33 mL) was added, to initiate the polymerization. The reaction was left for 24 hours before the polymerization was stopped by exposing the polymer dispersion to ambient air. The monomer conversion was determined gravimetrically according to the method mentioned above.

Alternatively, co-polymerized styrene with cationic co-monomer MTC, was prepared as follows using soap-free emulsion polymerization. In a 250 ml three-necked round bottom flask, a mixture containing ethanol (25 mL), water (75 mL), de-inhibited styrene (11 mL), MTC (0.24 mL) was prepared. The solution was degassed by sparging with N₂ gas for 45 minutes under stirring before it was heated to 70° C. To initiate the polymerization, an aqueous solution containing V-50 (2.4 mL as 0.08 M solution) prepared in a dropping funnel, was added into the dispersing mixture once temperature equilibrium had been reached. The reaction mixture was left for 24 h under reflux, before the polymerization was stopped by exposing the dispersion to ambient air.

### Synthesis of PS@TiO₂ Particles—

In a typical synthesis of PS@TiO₂ particles, titanium butoxide (TBOT) (0.3 mL) was mixed with ethanol (3.7 mL) to make an ethanolic TBOT solution with a total volume of 4 mL. Premade polystyrene (PS) dispersion (6.3 mL as 83.3 mg/ml dispersion) was mixed with ethanol (37 mL) in an Erlenmeyer flask equipped with a septum, without purification. The solution was stirred while the flask was sparged with N₂ gas for 5 minutes. The ethanolic TBOT solution was fed to the dispersion by dropwise addition within 45 minutes using a syringe pump, under stirring. Then, the solution was left to age for 24 hours after the alkoxide addition, before it was purified by three cycles of washing and centrifugation with ethanol.

In an alternative synthesis of PS@TiO₂ particles, pre-formed PS suspension (50 mL) was purified by three cycles of washing and centrifugation and re-dispersed with ethanol at a total volume of 5 mL. For PS synthesized by soap free emulsion polymerization, ethanol (40 mL) was added to the unpurified suspension (10 mL) before the first centrifugation cycle to reduce the dielectric constant of the continuous medium, hence allowing the PS particles to be sedimented. This process was repeated 5 times to reach a total of 50 mL PS suspension used. To create PVP—PS dispersion, concentrated PS suspension is diluted with ethanol (95 mL) containing PVP (0.8 g). The solution was stirred by magnetic bar for 24 hours at room temperature to ensure saturation coverage of PVP onto the PS spheres, then purified by three cycles of washing and centrifugation and re-dispersed with ethanol at a concentration of 65 mg/mL.

Subsequently, the PVP—PS dispersion (4.3 mL, total weight=0.29 g) and aqueous NaCl (2 mL as 0.005 M solution) was added into a 250 ml round bottom flask, and the total volume adjusted to 90 mL with ethanol. Then, the reaction chamber was purged with N₂ gas for 5 minutes. A pre-made ethanolic TBOT solution (EtOH: 9.0 mL, TBOT: 1.020 mL, [TBOT]: 0.03 M for total reaction volume of 100 mL) was fed to the flask using a syringe pump under stirring. The agitation was maintained at a constant speed as the solution was left to age for 24 hours. Finally, the core-shell dispersion was purified by three-cycles of washing-centrifugation and re-dispersed with ethanol.

For seeded growth of thicker shelled particle, the PS@TiO₂ particles were resuspended in ethanolic PVP solution (EtOH: 100 mL, PVP: 0.08 g) and the solution was stirred for 24 hours, then purified by three cycles of washing and centrifugation and re-dispersed with ethanol to a volume of 10 mL. The core-shell dispersion was diluted with ethanol (78 mL) containing NH3 (30 wt % in H2O, 0.4 wt %, 0.4 mL). After 2 hours of the alkoxide addition, the reaction mixture is purified by three cycles of washing-centrifugation.

The size of the PS and PS@TiO₂ particles was measured using Transmission Electron Microscopy operated at acceleration voltage of 120 kV. The PS@TiO₂ particles generally had an average particle size in the range of 200 to 900 nm, with a shell thickness in the range of 10 to 60 nm.

### Image Quality of White Ink Formulations in Drawdown Tests—

White Inks 1-7 were formulated as shown in Table 1 and evaluated for image quality in drawdown testing. All amounts are shown as wt. %.

TABLE 1
White ink formulations

| Components | Ink 1 | Ink 2 | Ink 3 | Ink 4 | Ink 5 | Ink 6 | Ink 7 |
|---|---|---|---|---|---|---|---|
| PS@TiO₂ | | | | | 10 | | |
| (229 nm) | | | | | | | |
| PS@TiO₂ | | | | | | 10 | |
| (599 nm) | | | | | | | |
| PS@TiO₂ | 10 | 10 | 10 | 10 | | | |
| (687 nm) | | | | | | | |
| PS@TiO₂ | | | | | | | 10 |
| (818 nm) | | | | | | | |
| PVP | 1.0 | 1.0 | 1.0 | 1.0 | 1.0 | 1.0 | 1.0 |
| S465 | | 1.0 | 1.0 | 1.0 | 1.0 | 1.0 | 1.0 |
| S2502 | | | 1.0 | 1.0 | 1.0 | 1.0 | 1.0 |
| BYK-349 | | | | 0.5 | 0.5 | 0.5 | 0.5 |
| EG/H₂O (50:50) | balance | balance | balance | balance | balance | balance | balance |

PS@TiO₂ refers to titania-coated polystyrene particles with particle sizes shown in parentheses;
PVP is polyvinylpyrrolidone;
S465 is Surfynol® 465 having an HLB value of 13;
S2502 is Surfynol® 2502 having an HLB value of 8;
BYK-349 is a polyether-modified siloxane surfactant;
EG/H2O is a 50:50 mixture of ethylene glycol and water.

Drawdown test images were produced by spreading each ink formulation over black-colored media at constant velocity using an automatic film applicator. The test images were visually inspected and qualitatively judged for image quality. The results are shown in Table 2.

TABLE 2
Qualitative Image Quality

| | Image Quality |
|---|---|
| Ink 1 | 1 |
| Ink 2 | 3 |
| Ink 3 | 4 |
| Ink 4 | 5 |
| Ink 5 | 5 |
| Ink 6 | 5 |
| Ink 7 | 5 |

5 = good image quality with even pigment coverage
1 = poor image quality with uneven pigment coverage

As expected, with no surfactant present (Ink 1) image quality was poor, exhibiting a high degree of mottling and uneven pigment distribution on the media surface. Addition of a conventional inkjet surfactant Surfynol® 465 (Ink 2) predictably improved image quality. Addition of a further Surfynol® 2502 (Ink 3) provided a further improvement in image quality. It was understood that the higher HLB surfactant (Surfynol® 465) had good dispersibility in the ink vehicle while the lower HLB surfactant (Surfynol® 2502) had preferential adsorption at the pigment surface, thereby providing improved pigment dispersion in combination. Further addition of BYK-349 (Inks 4-7) provided optimal image quality for the inks tested. It was understood that the relatively high diffusion coefficient of the polyether-modified siloxanes assists in avoiding surface tension gradients in the film layer of ink, thereby providing the smoothest and most uniform coating layer in drawdown tests.

### Opacity vs Particle Size—

Optical densities of unprinted black media and media printed with white inks were measured using a spectrophotometer. The difference in optical density (“Delta OD”) provides an indication of the opacity of each white ink formulation—the higher the delta OD, the high the opacity or hiding power of the white ink.

Using the optimized ink formulations described above for Inks 4-7, opacity was measured for different PS@TiO₂ particle sizes at 10 wt. %, 15 wt. % and 20 wt % pigment concentrations. The results are shown in Table 3.

TABLE 3
Opacity of white inks as function of
particle size and pigment concentration

| Particle | Delta OD | Delta OD | Delta OD |
|---|---|---|---|
| Size | (10 wt. %) | (15 wt. %) | (20 wt. %) |
| 299 nm | 0.40 | 0.43 | 0.88 |
| 599 nm | 0.63 | 0.90 | 1.09 |
| 687 nm | 0.83 | 0.91 | 1.06 |
| 818 nm | 0.78 | 0.86 | 1.04 |

As expected, opacity increased with increasing pigment concentration in each ink. However, in contrast with theoretical prediction and previous studies using hollow titania particles, maximum opacity was achieved with relatively large particle sizes in the range of about 500 to 900 nm.

Therefore, it was concluded that PS@TiO₂ particles have unique optical properties when formulated in white inkjet inks and provide a useful alternative to hollow titania particles described in the prior art. Moreover, PS@TiO₂ particles have a low density compared to solid titania particles and may be formulated into relatively stable ink formulations with minimal settling or flocculation of pigments during storage.

It will, of course, be appreciated that the present disclosure has been described by way of example only and that modifications of detail may be made within the scope of the disclosure, which is defined in the accompanying claims.

1. A white inkjet ink comprising:
an aqueous-based ink vehicle; and
white pigment particles dispersed in the ink vehicle,
wherein the pigment particles are core-shell particles having a core comprised of polystyrene and a shell comprised of titania.

2. The inkjet ink of claim 1, wherein the pigment particles have an average particle size in the range of 500 to 800 nm.

3. The inkjet ink of claim 2, wherein the pigment particles have a shell thickness in the range of 10 to 60 nm.

4. The inkjet ink of claim 1, wherein the titania shell is coated to the polystyrene core via a layer of polyvinylpyrrolidone.

5. The inkjet ink of claim 1, wherein the ink vehicle comprises one or more nonionic acetylenic surfactants.

6. The inkjet ink of claim 5, wherein the nonionic acetylenic surfactants each have an HLB value in the range of 7 to 14.

7. The inkjet ink of claim 5 comprising a first nonionic acetylenic surfactant having an HLB value in the range of 7 to 9; and a second nonionic acetylenic surfactant having an HLB value in the range of 12 to 14.

8. The inkjet ink of claim 5, wherein the ink vehicle further comprises a nonionic siloxane-based surfactant.

9. The inkjet ink of claim 1 wherein the ink vehicle comprises water and one or more co-solvents.

10. The inkjet of claim 8, wherein the ink vehicle comprises one or more co-solvents selected from the group consisting of: glycol ethers, 1,2-alkyldiols, ethylene glycol, diethylene glycol, triethylene glycol and glycerol.

11. A white pigment dispersion suitable for formulating an inkjet ink, the white pigment dispersion comprising core-shell particles having a core comprised of polystyrene and a shell comprised of titania, wherein the core-shell particles have an average particle size in the range of 500 to 900 nm.

12. The white pigment dispersion of claim 11, wherein the core-shell particles have a shell thickness in the range of 10 to 60 nm.

13. The white pigment dispersion of claim 11, wherein the titania shell is coated to the polystyrene core via a layer of polyvinylpyrrolidone.

14. A white inkjet ink comprising:
an aqueous-based ink vehicle; and
pigment particles having a titania outer surface dispersed in the ink vehicle,
wherein the ink vehicle comprises a first nonionic acetylenic surfactant having an HLB value in the range of 7 to 9 and a second nonionic acetylenic surfactant having an HLB value in the range of 12 to 14.

15. The inkjet ink of claim 14, further comprising a nonionic siloxane-based surfactant.

16. The inkjet ink of claim 14, wherein the pigment particles are core-shell particles having a core comprised of polystyrene and a shell comprised of titania.

17. The inkjet ink of claim 16, wherein the pigment particles have an average particle size in the range of 500 to 900 nm.

18. The inkjet ink of claim 16, wherein the pigment particles have a shell thickness in the range of 10 to 60 nm.

19. The inkjet ink of claim 16, wherein the titania shell is coated to the polystyrene core via a layer of polyvinylpyrrolidone.

20. The inkjet of claim 13, wherein the ink vehicle comprises one or more co-solvents selected from the group consisting of: glycol ethers, 1,2-alkyldiols, ethylene glycol, diethylene glycol, triethylene glycol and glycerol.
